(19) United States
(12) Patent Application Publication
(10) Pub. No.: US 2014/0305219 A1
(43) Pub. Date: Oct. 16, 2014

(54) CONICAL ULTRASONIC PROBE

(71) Applicants: GENERAL ELECTRIC COMPANY, Schenectady, NY (US); V & M DEUTSCHLAND GMBH, Dusseldorf (DE)

(72) Inventors: Stephan Falter, Simmerath (DE); Stefan Georg Nitsche, Muelheim (DE)

(73) Assignees: V & M Deutschland GmbH, Dusseldorf (DE); General Electric Company, Schenectady, NY (US)

(21) Appl. No.: 13/861,173

(22) Filed: Apr. 11, 2013

(51) Int. Cl. G01N 29/34

(52) U.S. Cl. CPC G01N 29/343
USPC 73/628; 73/632

(57) ABSTRACT

An array of ultrasonic transducers in a conical formation emits pulses of ultrasonic simultaneously so that an anomaly of any orientation in a test object can be detected efficiently.

### BACKGROUND OF THE INVENTION

The subject matter disclosed herein relates to an ultrasonic probe, in particular, to an arrangement of ultrasonic transducers in the probe.

Nondestructive testing devices can be used to inspect, measure, or test objects to identify and analyze anomalies in the objects. These devices allow an inspection technician to maneuver a probe at or near the surface of the test object in order to perform testing of both the object surface and its underlying structure. Nondestructive testing can be particularly useful in some industries, e.g., aerospace, power generation, and oil and gas transport or refining (e.g., pipes and welds). The inspection of test objects must take place without removal of the object from surrounding structures, and where hidden anomalies can be located that would otherwise not be identifiable through visual inspection. Ultrasonic testing is one example of nondestructive testing. When conducting ultrasonic testing, ultrasonic pulses or beams are emitted from ultrasonic transducers mounted in a probe and pass into a test object. As the ultrasonic energy, in the form of pulses or beams, pass into the object, various ultrasonic reflections called echoes occur as the ultrasonic beams interact with internal structures (e.g., surfaces or anomalies) of the test object. These echoes are detected by the ultrasonic transducers and are analyzed by processing electronics connected to the ultrasonic transducers.

A phased array ultrasonic probe comprises a plurality of electrically and acoustically independent ultrasonic transducers that incorporate piezoelectric material and are mounted in a single probe housing. During operation, predetermined patterns of electrical pulses are generated and transmitted to the probe. The electrical pulses are applied to the electrodes of the phased array transducers causing a physical deflection in the piezoelectric material which generate ultrasonic energy (e.g., ultrasonic signals or beams) that is transmitted into the test object to which the probe is coupled. By varying the timing of the electrical pulses applied to the phased array ultrasonic transducers, the phased array ultrasonic probe generates ultrasonic beams that impact the test object at different angles. This process of beam steering controls the direction of emitted ultrasonic energy to facilitate inspection of different regions of the test object to detect anomalies or characteristics therein. The amplitude and firing sequence of the individual transducers of the phased array probe can be programmably controlled in order to adjust the angle and penetration strength of the ultrasonic beam that is emitted into the test object. When the resulting ultrasonic echo returns to contact the surface of the piezoelectric material of a transducer it generates a detectable voltage difference across the transducer's electrodes which is then recorded as echo data by the processing electronics, and includes an amplitude and a return delay time. By tracking the time difference between the transmission of the electrical pulses and the receipt of the echo data, and measuring the amplitude of the received echo data, various characteristics of the test object can be determined such as its thickness, and the depth and size of anomalies therein.

In some applications, the ultrasonic probe comprises a one-dimensional or two-dimensional array of transducers mounted in a probe housing. A subset or subsets of transducers in the array are fired according to a series of programmed sequences in a scanning operation that impacts a test object and generates echo data. The echo data is analyzed by processing electronics which determines the characteristics of detected features, such as anomalies, in the test object. All the transducers in the array are not required to be fired for most scanning sequences and multiple scanning sequences are typically performed during each inspection. Although the ultrasonic transducers can be geometrically distributed in an array, the physical location of a particular transducer that detects an ultrasonic echo is not used for echo data analysis. By including this additional location information in the processing of echo data, processing time is reduced.

The discussion above is merely provided for general background information and is not intended to be used as an aid in determining the scope of the claimed subject matter.

### BRIEF DESCRIPTION OF THE INVENTION

One aspect of the invention is an ultrasonic probe comprising an array of ultrasonic transducers that emit pulses of ultrasonic energy at various angles simultaneously toward a test object so that an anomaly of any orientation in the component can be detected efficiently. An advantage that may be realized in the practice of some disclosed embodiments of the ultrasonic test system is that simultaneous multidirectional emission and detection of ultrasonic energy reduces scanning test time particularly if a geometric location of a detecting transducer in the array of transducers is used in the analysis.

In one embodiment, an ultrasonic testing system for inspecting a test object comprises an array of ultrasonic transducers arranged in a conical formation. Electronic processing circuitry connected to the array of ultrasonic transducers triggers a pulse of ultrasonic energy simultaneously emitted by all of the ultrasonic transducers in the array of ultrasonic transducers toward the test object.

In another embodiment, an ultrasonic processing system comprises an array of ultrasonic transducers arranged in a conical formation. Electronic processing circuitry connected to the array of ultrasonic transducers triggers a pulse of ultrasonic energy simultaneously emitted by all of the ultrasonic transducers in the array. A plurality of receiver circuits each receives an echo detected by a connected one of the ultrasonic transducers. The echo comprises an amplitude, wherein the electronic processing circuitry is capable of identifying a location of the ultrasonic transducer whose detection of the echo comprises a greater amplitude than remaining ones of the ultrasonic transducers.

In another embodiment, a method of operating an ultrasonic testing system comprises simultaneously firing a plurality of ultrasonic transducers configured as a conical array of ultrasonic transducers. The conical array of ultrasonic transducers are aimed at a test object when fired and they receive an echo from the test object caused by the simultaneous firing.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a perspective diagram of an exemplary probe comprising an array of ultrasonic transducers in a conical formation scanning a test object;

FIG. 2 is a schematic diagram of a side view of the exemplary probe of FIG. 1 connected to electronic processing circuitry for controlling scanning of a test object; and

FIG. 3 is a flow chart of a method of operating the exemplary probe of FIG. 1.

### DETAILED DESCRIPTION OF THE INVENTION

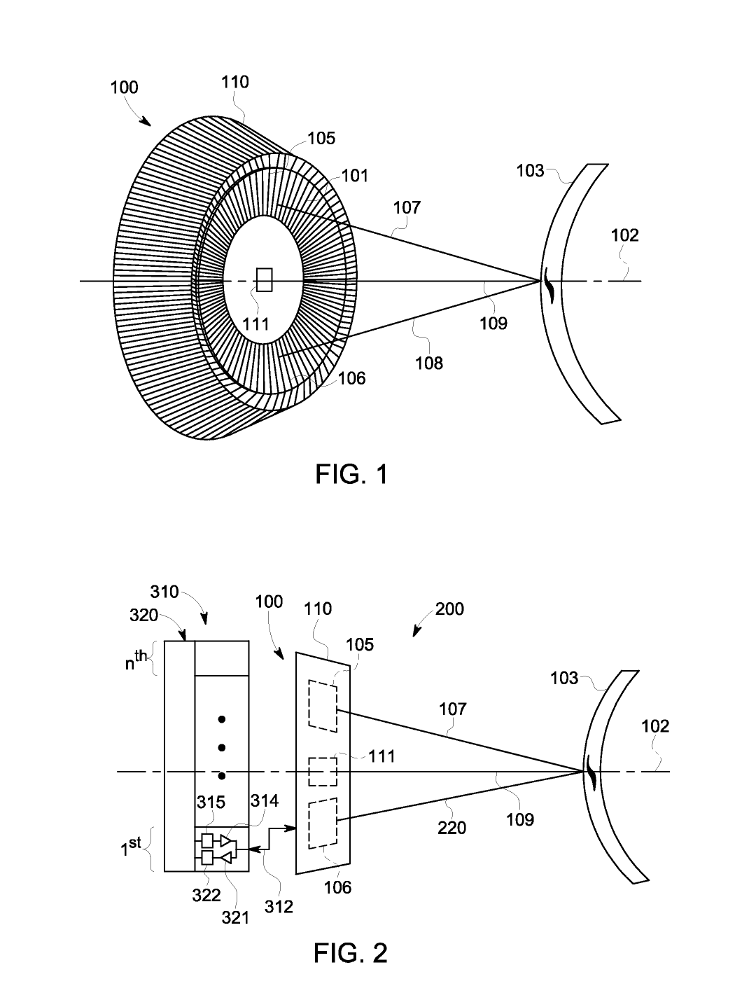

With reference to FIG. 1, there is illustrated a perspective view of an ultrasonic probe 100 comprising an array of ultrasonic transducers 101, and a center ultrasonic transducer 111 in a frusto-conical shaped ultrasonic probe housing 110. Although depicted and described herein as a single ultrasonic transducer, center ultrasonic transducer 111 can be interchanged with a plurality of ultrasonic transducers. Representative ultrasonic transducer 105 in the ultrasonic probe housing 110 emits a first ultrasonic pulse 107 toward test object 103 and representative ultrasonic transducer 106 in the ultrasonic probe housing 110 emits a second ultrasonic pulse 108 toward test object 103 simultaneously with the first ultrasonic pulse 107. In one alternative embodiment, center ultrasonic transducer 111 in a center of the conical array of ultrasonic transducers 101 is operable to emit a perpendicular ultrasonic pulse 109 relative to an external surface of test object 103 simultaneously with the ultrasonic pulses emitted by the conical array of ultrasonic transducers 101. Ultrasonic transducers 105, 106 are representative in the sense that all of the ultrasonic transducers in the conical array of ultrasonic transducers 101 simultaneously emit a pulse of ultrasonic energy during operation. The array of ultrasonic transducers 101 are defined herein as arranged in a conical formation in the sense that a simultaneous emission of pulses of ultrasonic energy from all the ultrasonic transducers in the array of ultrasonic transducers 101 results in a convergence of the ultrasonic pulses toward a probe axis 102.

The arrangement of the array of ultrasonic transducers 101 in a conical formation, as illustrated in FIG. 1, is not intended to limit possible configurations of the ultrasonic transducers, as the number and arrangement of ultrasonic transducers can assume various quantities and layouts. For example, the array of ultrasonic transducers 101 can comprise one hundred and twenty eight ultrasonic transducers. As illustrated in the embodiment of FIG. 1, the array of ultrasonic transducers 101 are equally distributed around the circular geometry of the conical formation. In one embodiment, the conical formation comprises the array of ultrasonic transducers 101 equally distributed in a circular arrangement centered around a probe axis 102 wherein each ultrasonic transducer is oriented such that it is tilted toward the probe axis 102, therefore, the ultrasonic pulses emitted by all of the ultrasonic transducers converge toward the probe axis 102. Center ultrasonic transducer 111 emits a perpendicular ultrasonic pulse 109 relative to the external surface of test object 103. Each ultrasonic transducer in the array of ultrasonic transducers 101 and center ultrasonic transducer 111 emits pulses of ultrasonic energy toward a test object 103 in a direction that is fixed according to the orientation of the ultrasonic transducer in the ultrasonic probe housing 110. Each ultrasonic transducer in the array of ultrasonic transducers 101, and center ultrasonic transducer 111, also detects ultrasonic echoes as reflected by test object 103. A portion of the emitted ultrasonic pulses 107, 108, 109 are reflected back to the ultrasonic transducers as echoes by the test object 103 upon the emitted ultrasonic pulses 107, 108, 109 impacting an exterior surface of the test object 103 and upon impacting an interior structure of the test object 103, such as an anomaly 104. The ultrasonic probe 100 is typically acoustically coupled to the test object 103 using a water column (not shown) as a medium for better transmission of ultrasonic pulses and reception of ultrasonic echoes.

As illustrated in the schematic side view of FIG. 2, ultrasonic test system 200 comprises electronic processing circuitry 310, connected to the array of ultrasonic transducers 101, which controls operation of the ultrasonic probe 100. A time window during which an expected echo will return to an ultrasonic transducer in the ultrasonic probe 100 is known beforehand and can be programmed to be received at the expected moment by the electronic processing circuitry 310. It is known that an orientation of an anomaly 104 in the test object 103 affects its detectability based on the impact angle of the emitted ultrasonic pulses 107, 108, 109. If the emitted ultrasonic pulses 107, 108, 109 impact an anomaly 104 in the test object 103 at an angle similar to an orientation angle of the anomaly 104, the return echo amplitude is greater, i.e., “enhanced,” and is more easily detected. In the conical formation of the array of ultrasonic transducers 101 shown in FIG. 1, one or more of the ultrasonic transducers will detect an echo having an enhanced amplitude, as compared with other ultrasonic transducers in the array of ultrasonic transducers 101. This occurs because all the ultrasonic transducers in the array of ultrasonic transducers 101 simultaneously emit ultrasonic pulses at equally spaced angles. One or more of these ultrasonic pulses will impact an anomaly at a more comparable angle than other ones of the ultrasonic transducers, thereby generating an echo having an enhanced amplitude.

Typically, more than one of the ultrasonic transducers detects an echo having an enhanced amplitude and these ultrasonic transducers are typically located adjacent to each other in the array of ultrasonic transducers 101. The location in the array of ultrasonic transducers 101 of the one or more ultrasonic transducers that detect an echo having an enhanced amplitude can then be used to determine location and orientation characteristics of the anomaly 104. This occurs because the conical arrangement of the array of ultrasonic transducers 101 are equally distributed over an entire 360 degree range of possible angles. The location of the ultrasonic transducer that detects an echo having an enhanced amplitude is obtained by correlating the detected enhanced amplitude data with a particular ultrasonic transducer having a known geometric location in the array of ultrasonic transducers 101. For example, each of the ultrasonic transducers in the array of ultrasonic transducers 101 can be indexed by programmably assigning each ultrasonic transducer an identification number and storing the identification number along with its corresponding ultrasonic transducer location in a memory of the electronic processing circuitry 310. Thereafter, detected echo data, in particular a detected echo data having an enhanced amplitude, can be correlated with the identification number, and a location in the array, of the particular ultrasonic transducer that detected the enhanced echo data.

As explained above, the orientation of the anomaly 104 as well as the impact angle of the emitted ultrasonic pulse 107, 108, 109 determines a magnitude of the reflected echo. By simultaneously firing all of the ultrasonic transducers in the array of ultrasonic transducers 101 and, alternatively, the center ultrasonic transducer 111, toward a test object 103 a particular one or more of the ultrasonic transducers will detect an enhanced amplitude echo based on an orientation of the ultrasonic transducer that emitted the corresponding ultrasonic pulse 107 and on the orientation of the anomaly 104. The location of the ultrasonic transducers that detected an enhanced amplitude echo is used during echo data analysis to determine characteristics of the anomaly 104 such as its location in the test object 103.

With reference to FIG. 2, a representative individual ultrasonic transducer 106 of the array of ultrasonic transducers 101 is illustrated as an exemplary ultrasonic transducer for the description that follows. It should be understood that the operation of the ultrasonic transducer 106 as described herein also applies to each of the ultrasonic transducers in the array of ultrasonic transducers 101 and center ultrasonic transducer 111. As shown, ultrasonic transducer 106 is in electrical communication with electronic processing circuitry 310 over electrical communication line 312. Electronic processing circuitry 310 includes a pulser 314 that transmits electrical pulses to a connected one of the ultrasonic transducers 106 causing the ultrasonic transducer 106 to emit ultrasonic pulses. Transmission circuit 315 comprises timing data for controlling the timing of the electrical pulses transmitted by pulser 314. Ultrasonic transducer 106 is also in electrical communication with an amplifier 321 and receiver circuit 322 over electrical communication line 312. Amplifier 321 and receiver circuit 322 receive ultrasonic echo data detected by a connected one of the ultrasonic transducers 106.

Electronic processing circuitry 310 includes standard control electronics 320 electrically connected to the individual transmitter circuits 315, receiver circuits 322, pulsers 314, and amplifiers 321. Standard control electronics 320 feeds the timing control data to all the transmitter circuits 315 and pulsers 314 connected to it, e.g. 1^{st} through n^{th} as shown in FIG. 2 for a number n of ultrasonic transducers in the array of ultrasonic transducers 101, for coordinating the electrical signals provided by pulsers 314. Standard control electronics 320 includes an analog-to-digital (A/D) converter for digitizing received ultrasonic echoes, and a number of summer circuits connected to the A/D converters for beam forming and generating A-scan information as an output. Standard control electronics 320 receives echo data from all the amplifiers 321, and receiver circuits 322 connected to it, e.g. 1^{st} through n^{th} as shown in FIG. 2 for a number n of ultrasonic transducers in the array of ultrasonic transducers 101. In one embodiment, electronic processing circuitry 310 is capable of carrying out multiple parallel evaluations on the incoming ultrasonic echo data detected by the conical array of ultrasonic transducers 101 and center ultrasonic transducer 111. This parallel evaluation of incoming ultrasonic echo data provides increased testing efficiency. Standard control electronics 320 is comprised of, for example, a field programmable gate array (FPGA), an application specific integrated circuit (ASIC), or a combination thereof. Standard control electronics 320 also includes memory for storing: various programming for performing ultrasonic inspections such as inspection plans; digital information such as parameters used for transmission patterns and timing control data; digitized ultrasonic echo data; A-scan information; and the identification and location information of all the ultrasonic transducers in the array of ultrasonic transducers 101.

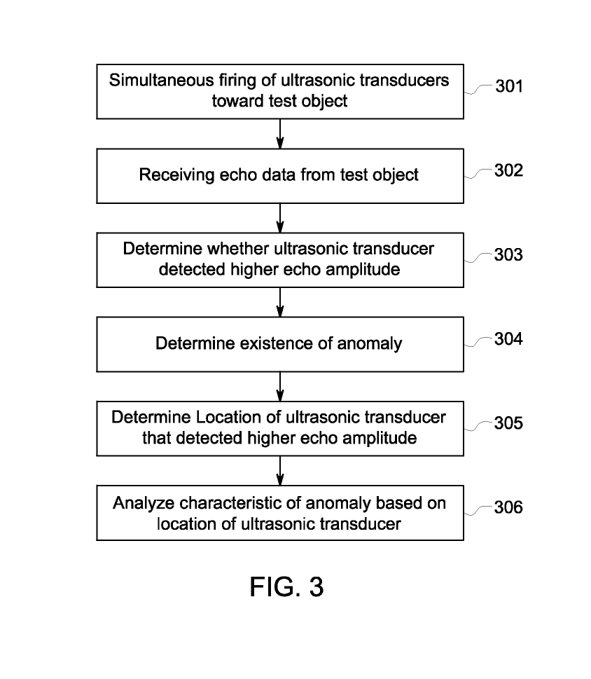

FIG. 3 illustrates a flow diagram of the operation of ultrasonic probe 100. Operation of ultrasonic probe 100 begins at step 301 by simultaneously firing all of the ultrasonic transducers in the array of ultrasonic transducers 101 and, alternatively, center ultrasonic transducer 111 toward a test object 103. This results in receiving echo data reflected from the test object at the ultrasonic transducers in the array of ultrasonic transducers 101 at step 302. The next step, step 303, involves determining if any of the ultrasonic transducers in the array of ultrasonic transducers 101 detected an echo having a higher amplitude than remaining ones of the array of ultrasonic transducers 101. If so, the existence of an anomaly 104 in the test object is confirmed at step 304. The next step, step 305, is to determine a location, in the array of ultrasonic transducers 101 and center ultrasonic transducer 111, of the ultrasonic transducer or transducers that detected the echo having a higher amplitude. Based on the location of that transducer, characteristics of the anomaly 104 can be analyzed at step 306.

In view of the foregoing, embodiments of the invention increase testing efficiency by simultaneously emitting pulses of ultrasonic energy toward a test object 103 in order to detect anomalies having orientations at any angle. A technical effect is that the resultant processing of received ultrasonic echo data will include enhanced ultrasonic echo data received at one or more particular ultrasonic transducers at known locations in the array of ultrasonic transducers 101.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “electronics,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An ultrasonic testing system for inspecting a test object, the ultrasonic testing system comprising:
an array of ultrasonic transducers arranged in a conical formation; and
electronic processing circuitry connected to the array of ultrasonic transducers, the electronic processing circuitry for triggering a pulse of ultrasonic energies simultaneously emitted by all of the ultrasonic transducers in the array of ultrasonic transducers toward the test object.

2. The system of claim 1, wherein the conical formation comprises a plurality of ultrasonic transducers equally distributed in a circular arrangement and oriented such that the ultrasonic energies simultaneously emitted by all of the ultrasonic transducers converge.

3. The system of claim 1, wherein the electronic processing circuitry includes stored information for identifying a location in the array of ultrasonic transducers of the one or more of the ultrasonic transducers in the array of ultrasonic transducers detecting the enhanced amplitude of the reflected pulse.

4. The system of claim 3, wherein the stored information for identifying the location in the array of ultrasonic transducers is an input to the electronic processing circuitry for analyzing characteristics of the anomaly.

5. The system of claim 1, wherein the array of ultrasonic transducers is a one dimensional array.

6. The system of claim 1, wherein the array of ultrasonic transducers is a multi-dimensional array.

7. The system of claim 1, wherein a determination by the electronic processing circuitry that the one or more of the ultrasonic transducers in the array of ultrasonic transducers detected an enhanced amplitude of the pulse of ultrasonic energy indicates a presence of an anomaly in the test object.

8. The system of claim 7, wherein a location in the conical formation of the one or more of the ultrasonic transducers in the array of ultrasonic transducers that detected an enhanced amplitude of the pulse of ultrasonic energy indicates an orientation of the anomaly in the test object.

9. An ultrasonic processing system comprising:
an array of ultrasonic transducers arranged in a conical formation;
electronic processing circuitry connected to the array of ultrasonic transducers, the electronic processing circuitry for triggering a pulse of ultrasonic energy simultaneously emitted by all of the ultrasonic transducers in the array of ultrasonic transducers; and
a plurality of receiver circuits each electrically connected to one of the ultrasonic transducers in the array of ultrasonic transducers for receiving an echo detected by a connected one of the ultrasonic transducers in the array of ultrasonic transducers, the echo comprising an amplitude, wherein the electronic processing circuitry is capable of identifying a location of one of the ultrasonic transducers in the array of ultrasonic transducers whose detection of the echo comprises a greater amplitude than remaining ones of the ultrasonic transducers in the array of ultrasonic transducers.

10. The system of claim 9, wherein the electronic processing circuitry comprises memory for storing information for identifying the location of the one of the ultrasonic transducers in the array of ultrasonic transducers whose detection of the echo comprises the greater amplitude.

11. The system of claim 10, wherein the electronic processing circuitry is capable of determining the existence of an anomaly based on the detected echo comprising a greater amplitude in the one of the ultrasonic transducers in the array of ultrasonic transducers.

12. The system of claim 11, wherein electronic processing circuitry uses the location of the one of the ultrasonic transducers in the array of ultrasonic transducers for analyzing characteristics of the anomaly.

13. The system of claim 9, wherein one of the characteristics of the anomaly includes an orientation of the anomaly.

14. The system of claim 9, wherein the array of ultrasonic transducers is a multi-dimensional array.

15. A method of operating an ultrasonic testing system comprising:
simultaneously firing a plurality of ultrasonic transducers configured as a conical array of ultrasonic transducers, including aiming the conical array of ultrasonic transducers at a test object; and
the conical array of ultrasonic transducers receiving an echo from the test object caused by the simultaneously fired plurality of ultrasonic transducers.

16. The method of claim 15, further comprising determining whether one or more of the plurality of ultrasonic transducers in the conical array of ultrasonic transducers detected a substantially greater amplitude of the echo than other ones of the ultrasonic transducers in the conical array of ultrasonic transducers.

17. The method of claim 16, further comprising determining that the test object contains an anomaly in response to the step of determining that one or more of the plurality of ultrasonic transducers in the conical array of ultrasonic transducers detected the substantially greater amplitude of the echo.

18. The method of claim 17, further comprising determining a location in the conical array of ultrasonic transducers of the one or more ultrasonic transducers that detected the substantially greater amplitude of the echo.

19. The method of claim 17, further comprising determining a characteristic of the anomaly in response to the step of determining the location in the conical array of ultrasonic transducers of the one or more of the ultrasonic transducers that detected the substantially greater amplitude of the echo.

20. The method of claim 15, further comprising firing one or more ultrasonic transducers positioned in a center of the conical array of ultrasonic transducers, wherein the one or more ultrasonic transducers are each further positioned to emit an ultrasonic pulse in a direction perpendicular to an exterior surface of the test object.
